(19) United States
(12) Patent Application Publication
(10) Pub. No.: US 2025/0316153 A1
(43) Pub. Date: Oct. 9, 2025

(54) MODULAR SENSOR SYSTEM AND METHOD OF INSTALLING THE SAME

(71) Applicant: Vicon Industries, Inc., Hauppauge, NY (US)

(72) Inventors: Hlynur Vagn Atlason, New York, NY (US); Kai Coffey Valencia, Brooklyn, NY (US); Chaim Shain, Parkland, FL (US); Robert Edward Germain, Middletown, MD (US); Alma Jaze, Astoria, NY (US)

(73) Assignee: Vicon Industries, Inc., Hauppauge, NY (US)

(21) Appl. No.: 19/171,955

(22) Filed: Apr. 7, 2025

Related U.S. Application Data
(60) Provisional application No. 63/575,999, filed on Apr. 8, 2024.

(51) Int. Cl. G08B 13/196

(52) U.S. Cl. CPC G08B 13/19656; G08B 13/19632; G08B 13/19636; G08B 13/1966

(57) ABSTRACT

A modular sensor system configured for providing a sensor unit that is contextualized for an installation scenario is provided. The modular sensor system comprises one or more sensor modules; one or more mounting bases, wherein each mounting base is configured for being mounted to a mounting location; and one or more fixtures, wherein each of the one or more fixtures includes one or more mounting ports, wherein each of the one or more fixtures are configured for being releasably coupled to any of the one or more mounting bases using a first universal connection mechanism, and wherein each of the one or more mounting ports is configured for being releasably coupled with any of the sensor modules included in the one or more sensor modules using a second universal connection mechanism.

### CROSS-REFERENCE TO RELATED APPLICATIONS

This application claims the benefit of U.S. Patent Application No. 63/575,999 filed on Apr. 8, 2024, the contents of which are incorporated by reference in its entirety.

### FIELD OF THE INVENTION

The present invention is related to a modular sensor system, and more specifically, to a modular sensor system that may include various combinations of one or more fixtures and mounting bases for use with a corresponding number of sensor modules to form a sensor unit that is contextualized for an installation scenario, and method of installing the same.

### BACKGROUND OF THE INVENTION

Security systems and sensors are useful in providing security, protection, and information to people and property. For example, businesses, schools, prisons, government facilities, and homeowners regularly install security cameras and other sensors around their businesses, homes, and other property to provide video and audio monitoring and surveillance. That is, security systems may allow security personnel to remotely monitor activity around a property and in the event of a burglary, theft, invasion, damage to property, or other criminal activity the captured video and/or audio data can be used to identify the involved individuals and help determine what happened. Security systems and sensors can also provide useful data to improve day-to-day operations for the above-referenced entities.

The needs of businesses and homeowners, areas of interest, and their corresponding environments are unique at each location. There are currently a wide variety of camera and other sensor types that are available to address the needs at a given location, along with specialized mounting components that are used with each camera or sensor to accommodate each particular installation. Having to account for the multitude of different types of cameras or other sensors and their corresponding mounting components increases the complexity of planning and obtaining the required components necessary to complete the installation of these components at a given location. It also makes it difficult for a person installing these systems given the lack of uniformity in how each of the cameras and sensors are assembled and mounted. Furthermore, the installer typically needs one or more tools in order to install the camera or sensor to the mounting components or interchange them after their initial installation, which further complicates and delays the initial installation or reconfiguration process. The accumulation of the above-referenced factors results in a complex and cumbersome process for selecting and installing existing camera and sensor systems.

Accordingly, what is needed is an improved system and method for providing a modular sensor system that allows for interchangeability between its components to provide a sensor unit that can be installed in an efficient manner. What is further needed a simplified system for installing and reconfiguring camera or sensors to the mounting components with the use of minimal or no tools. The present invention fills these needs as well as other needs.

### SUMMARY OF THE INVENTION

Briefly described, a modular sensor system configured for providing a sensor unit that is contextualized for an installation scenario is provided. The modular sensor system comprises one or more sensor modules; one or more mounting bases, wherein each mounting base is configured for being mounted to a mounting location; and one or more fixtures, wherein each of the one or more fixtures includes one or more mounting ports. Each of the one or more fixtures are configured for being releasably coupled to any of the one or more mounting bases using a first universal connection mechanism, and each of the one or more mounting ports is configured for being releasably coupled with any of the sensor modules included in the one or more sensor modules using a second universal connection mechanism. In certain exemplary embodiments, the one or more mounting bases may be a plurality of mounting bases, the one or more fixtures may be a plurality of fixtures, and the one or more sensor modules may be a plurality of sensor modules.

The modular sensor system may further comprise a network hub including a power interface, wherein the power interface is configured to provide power from a power source to the one or more sensor modules when releasably coupled to any of the one or more fixtures. The network hub may be releasably coupled to any of the one or more mounting bases. The network hub may include a network interface, wherein the network interface is configured to provide communication between the one or more sensor modules and a network when releasably coupled to any of the one or more fixtures. The power interface and the network interface may include uniform data I/O and power sockets and connectors.

The first universal connection mechanism may comprise a first interlocking feature associated with any of the one or more mounting bases, and a second interlocking feature associated with any of the one or more fixtures, wherein the first interlocking feature is configured to releasably engage the second interlocking feature. One of the first interlocking feature or the second interlocking feature may include a protrusion, and the other of the first interlocking feature or the second interlocking feature may include a groove, wherein the protrusion is configured for being twistably inserted into the groove to releasably couple any of the one or more fixtures to any of the one or more mounting bases.

The second universal connection mechanism may comprise a first interlocking feature associated with each mounting port in any of the one or more fixtures, and a second interlocking feature associated with each of the one or more sensor modules, and the first interlocking feature is configured to releasably engage the second interlocking feature. One of the first interlocking feature or the second interlocking feature may include a protrusion, and the other of the first interlocking feature or the second interlocking feature may include a groove, and wherein the protrusion is configured for being twistably inserted into the groove to releasably couple any of the one or more sensor modules to any of the mounting ports on the one or more fixtures. In one exemplary embodiment, the first universal connection mechanism and the second universal connection mechanism may be the same.

Each of the one or more sensor modules may comprise a processor and a memory. The one or more sensor modules may comprise at least one of: a camera, a microphone, a speaker, an environmental sensor, a thermal sensor, a radar device, a lidar device or an internet-of-things (IoT) device.

The mounting location may be at least one of an interior surface of a ceiling, an electrical box mounting in the ceiling, an exterior surface of the ceiling, a recess within the ceiling, an interior surface of a wall, an exterior surface of the wall, or a corner defined by two adjacent walls.

In another aspect, a method of installing a sensor unit using a modular sensor system is provided, wherein the modular sensor system provides one or more mounting bases, one or more fixtures, and one or more sensor modules. The method comprises: a) selecting a mounting base from the one or more mounting bases; b) securing the mounting base to a mounting location; c) electrically connecting a network hub to a power supply and a network, and releasably coupling the network hub to the mounting base; d) selecting a fixture from the one or more fixtures, wherein each of the one or more fixtures includes one or more mounting ports; e) releasably coupling the selected fixture to the selected mounting base using a first universal connection mechanism; f) selecting a number of sensor modules from the one or more sensor modules corresponding to the number of mounting ports on the selected fixture; and g) releasably coupling the selected sensor modules to the selected fixture using a second universal connection mechanism and electrically connecting the sensor modules to the network hub.

In an exemplary embodiment, after step g), the method further comprises the steps of: uncoupling the selected sensor modules from the one or more mounting ports of the selected fixture and electrically disconnecting the selected sensor modules from the network hub; and returning to step f).

In another exemplary embodiment, after step g), the method further comprises the steps of: uncoupling the selected sensor modules from the one or more mounting ports of the selected fixture and electrically disconnecting the selected sensor modules from the network hub; uncoupling the selected fixture from the mounting base; and returning to step d).

In yet another exemplary embodiment, after step g), the method further comprises the steps of: uncoupling the selected sensor modules from the one or more mounting ports of the selected fixture and electrically disconnecting the selected sensor modules from the network hub; uncoupling the selected fixture from the mounting base; uncoupling the network hub form the mounting base; unsecuring the mounting base from the mounting location; and returning to step a).

Numerous applications, some of which are exemplarily described below, may be implemented using the present invention.

### BRIEF DESCRIPTION OF THE DRAWINGS

The above-mentioned and other features and advantages of this invention, and the manner of attaining them, will become apparent and be better understood by reference to the following description of the invention in conjunction with the accompanying drawing, wherein:

FIG. 1 is a perspective view of an exemplary sensor unit that may be provided by a modular sensor system in accordance with an aspect of the present invention;

FIG. 2 is an exploded view of the exemplary sensor unit shown in FIG. 1;

FIG. 3 is a perspective view of an exemplary mounting base that may be included in the sensor unit that is mounted to a mounting surface;

FIG. 4 is an exploded view of the exemplary sensor unit shown in FIG. 1 being mounted to the mounting surface;

FIG. 5 is an enlarged view of the sensor unit shown in FIG. 1 with certain portions in phantom to show an exemplary first universal connection mechanism being used to releasably couple the mounting base to an exemplary fixture;

FIG. 6 is a perspective view of an exemplary network hub that may be used in the modular sensor system;

FIG. 7 is an exploded view of the network hub and the mounting base that may be used in the modular sensor system;

FIG. 8 is a front view of the sensor unit shown in FIG. 1 with certain portions in phantom to show an exemplary second universal connection mechanism being used to releasably couple an exemplary sensor module to the fixture;

FIG. 9 is an enlarged view with certain portions in phantom to show the electrical connection between the sensor module and the network hub;

FIG. 10 is an enlarged view showing the sensor module as it is being releasably coupled to the fixture using the second universal connection mechanism prior to the sensor module being electrically connected to the network hub as seen in FIG. 9;

FIG. 11 is a partial perspective view of the sensor module releasably coupled to the fixture;

FIG. 12 illustrates an array of mounting configurations and fixture embodiments in accordance with aspects of the present invention;

FIG. 13 is an exploded view of another exemplary sensor unit including another exemplary mounting base;

FIG. 14 is an exploded view of yet another exemplary sensor unit including another exemplary mounting base;

FIG. 15 is an exploded view of a further exemplary sensor unit including another exemplary mounting base;

FIG. 16 is an exploded view of another exemplary sensor unit including another exemplary mounting base;

FIG. 17 is an exploded view of yet another exemplary sensor unit including another exemplary mounting base;

FIG. 18 is an exploded view of a further exemplary sensor unit including another exemplary mounting base;

FIG. 19 illustrates an array of mounting configurations and fixture embodiments in accordance with aspects of the present invention;

FIG. 20 is a perspective view of an exemplary fixture that may be used in the sensor unit including two mounting ports;

FIG. 21 is an exploded view of the exemplary fixture shown in FIG. 20 with certain portions shown in phantom;

FIG. 22 is a front view of the exemplary fixture shown in FIG. 20 with certain portions shown in phantom;

FIG. 23A is a partial bottom perspective view of the exemplary fixture shown in FIG. 20 with certain portions shown in phantom;

FIG. 23B is a side view of the exemplary fixture shown in FIG. 19 releasably coupled to the exemplary mounting base shown in FIG. 3 using the first universal connection mechanism, releasably coupled to a sensor module using the second universal connection mechanism, and being electrically connected to the network hub;

FIG. 24 is a perspective view of a further exemplary fixture that may be used in the sensor unit including three mounting ports;

FIG. 25 is a perspective view of yet another exemplary fixture that may be used in the sensor unit using including four mounting points; and

FIG. 26 is a flow chart illustrating an exemplary method of assembling and installing a sensor unit utilizing the modular sensor system in accordance with aspects of the present invention.

### DETAILED DESCRIPTION OF THE EMBODIMENTS

To simplify the planning, coordination and/or installation of a sensor unit and reduce the assortment of tools and components necessary to install the sensor system, the present invention is directed to a modular sensor system that allows for the selective configuration of the sensor unit so that may be adapted to a variety of different mounting locations and environments. The modular sensor system may include one or more mounting bases mountable to a variety of mounting locations or surfaces, one or more fixtures configured to be selectively connected to each of the one or more mounting bases, and one or more sensor modules configured to be selectively connected to each of the one or more fixtures. Each of the mounting bases may be releasably connected to each of the fixtures using a first universal connection mechanism to provide interchangeability between different mounting bases and fixtures to properly contextualize the sensor unit in a given environment. Further, each of the sensor modules may be releasably connected to each of the fixtures using a second universal connection mechanism to allow any of the sensor modules to be mounted or interchanged with the selected fixture. It should be understood that the first and second universal connection mechanisms may be the same or different. The modular sensor system may further comprise a network hub that includes uniform data I/O and power sockets and connectors that are configured to be selectively connected any of the one of more sensor modules to provide power and data communication with the one or more sensor modules.

The modular sensor system of the present invention facilitates easy installation of the sensor unit by requiring no additional tools beyond those that may be needed to secure a mounting base to a mounting surface. Further, in certain embodiments, no additional active or passive electronics are required to subsequently expand from using a single sensor module to more than one sensor module. However, in other embodiments, additional active or passive electronics may be used in expanding a single sensor module to more than one sensor module.

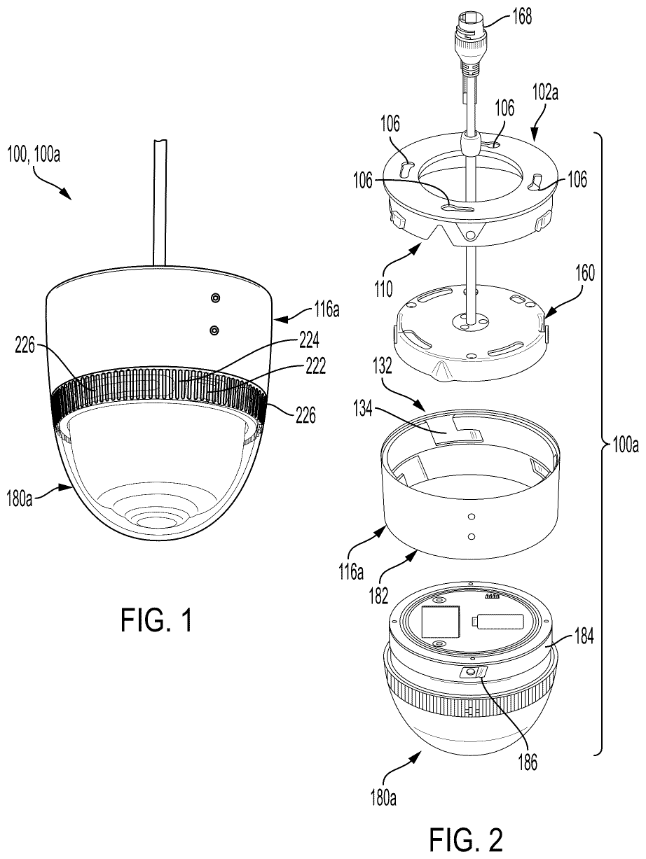

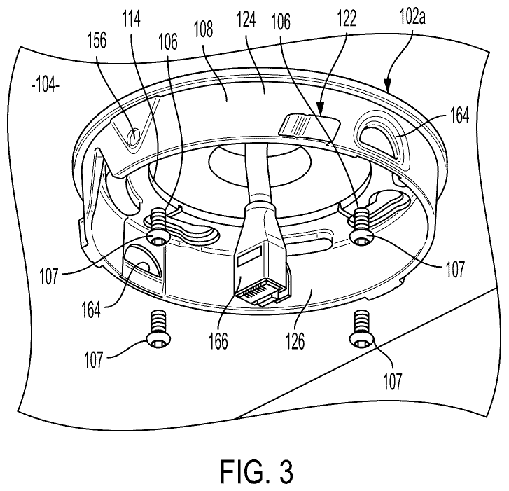

With reference to the drawings, and initially to FIGS. 1 and 2, an exemplary sensor unit is identified with reference numeral 100. Sensor unit 100a is one exemplary, non-limiting version of a sensor unit that may be provided using the modular sensor system in accordance with an aspect of the present invention. For example, with additional reference to FIG. 3, sensor unit 100a may comprise a mounting base, such as a hollow surface mount 102a, selected from one or more mounting bases 102 included in the modular sensor system. It should be understood that the one or more mounting bases 102 may be a plurality of mounting bases. First mounting base 102a may include a first end and a second end. The first end of mounting base 102a is configured to be coupled to a mounting location, such a surface 104, via one or more mounting points 106 using one or more fasteners 107. The second end of mounting base 102a may further include a sidewall 108 that defines a cavity 110 for receiving at least a portion of a network hub 160.

In certain exemplary embodiments, the first end of mounting base 102a may be configured with an aperture 114 defined therein. Aperture 114 of the first end of mounting base 102a may enable one or more network and/or power cables from network hub 160 to be routed therethrough. In certain exemplary embodiments, sidewall 108 of the second end of mounting base 102a may be generally circular in shape and extend substantially perpendicular from the first end of mounting base 102a. In some embodiments, sidewall 108 may extend from the first end to the second end of mounting base 102a to form an outer edge at the second end of mounting base 102a. It should be understood that sidewall 108 may be any desired shape, including but not limited to, square, rectangular, pentagonal, hexagonal, octagonal, or any other shape suitable for coupling with a fixture 116 selected from one or more fixtures 116 included in the modular sensor system.

Exemplary sensor unit 100a may further comprise a fixture, such as a fixture 116a, selected from one or more fixtures 116 included in the modular sensor system. It should be understood that the one or more fixtures may be a plurality of fixtures. Mounting base 102a may be configured to be releasably coupled to a first end of fixture 116a using the first universal connection mechanism. For example, the first universal connection mechanism may comprise a first interlocking feature associated with sidewall 108 of mounting base 102a, and a second interlocking feature associated with fixture 116a, wherein the first interlocking feature may be configured to releasably engage the second interlocking feature to allow fixture 116a to be releasably coupled to mounting base 102a. It should be understood that the first and second interlocking features can take many different forms and nothing in the present description is intended to limit the scope of the present invention. In general, either the first interlocking feature or the second interlocking feature may include a protrusion, and the other of the interlocking feature or the second interlocking feature may include a groove, and the protrusion may be configured to be twistably inserted into the groove to releasably couple fixture 116a to mounting base 102a.

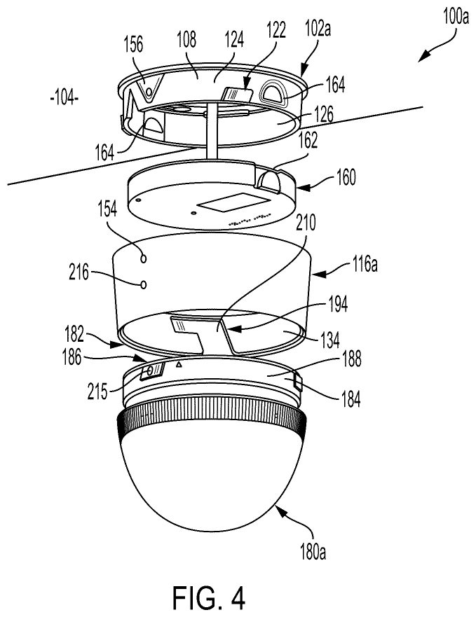

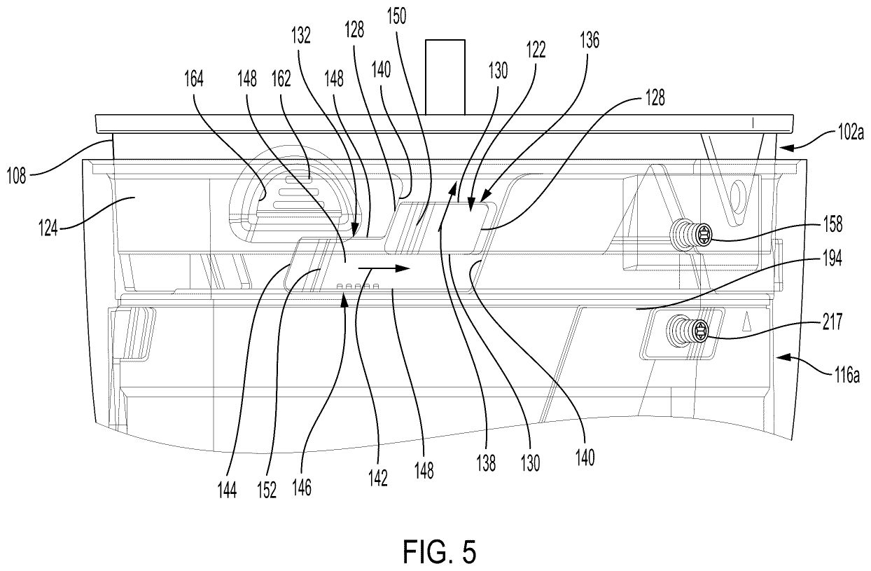

In a non-limiting example, with additional reference to FIGS. 3 and 4, sidewall 108 of the second end of mounting base 102a may include a plurality of protrusions 122 that are spaced around and extending from an outer surface 124 of sidewall 108. It is also contemplated that sidewall 108 of the second end of mounting base 102a may include protrusions 122 spaced around an inner surface 126 of sidewall 108. One or more of protrusions 122 may be, for example, shaped as quadrilateral, such as a parallelogram, that includes a first set of opposing sidewalls 128 and a second set of opposing sidewalls 130. Protrusions 122 may be configured to be releasably positioned within with corresponding grooves 132 defined in the first end of fixture 116 to secure fixture 116a to mounting base 102a. In one exemplary embodiment, protrusions 122 spaced around the outer surface of sidewall 108 may be releasably positioned within corresponding grooves 132 defined in an inner surface 134 of the first end of fixture 116. To secureably connect fixture 116a to mounting base 102a, each protrusion 122 may be positioned within a first leg 136 of respective groove 132, and then fixture 116a is moved in a direction 138. To guide movement of protrusion 122 in direction 138, first set of opposing sidewalls 128 may be disposed at an angle that matches opposing walls 140 of first leg 136 of groove 132. Further, each protrusion 120 may then be securely positioned within its respective groove 132 by twisting fixture 116a in a direction 142 so that protrusion 120 moves to a distal end 144 of a second leg 146 of groove 130. To guide movement in direction 142, second set of opposing sidewalls 130 may be disposed at an angle that matches opposing walls 148 of second leg 146 of groove 130. Both protrusion 122 and an inner surface 148 of second leg 146 of groove 130 may optionally include respective ridges 150, 152 that interact with one another to generate a snap feel and/or sound to indicate to a user that protrusion 122 has reached a fully secure position at distal end 144 of second leg 146. In addition, or alternatively, fixture 116a may have a first aperture 154 defined therein that is positioned to line up with a receiving aperture 156 on sidewall 108 of mounting base 102a when fixture 116a is securely connected to mounting base 102a so that a captive lock screw 158 can be disposed therein to prevent authorized removal of fixture 116a from mounting base 102a.

In other exemplary embodiments, the first and second interlocking features may take the form of a threaded connection. Alternatively, the first interlocking feature may include a ramp and the second interlocking feature may include a lip oriented to engage with a terminal end of the ramp. Any other combination of first and second interlocking features suitable for releasably coupling mounting base 102a and fixture 116a is contemplated herein.

While the above discussion included embodiments that provided for mounting base 102a that is separate from fixture 116, it should be understood that it is within the scope of the present invention to provide fixture 116 that has an integral mounting base to it to be mounted directly to a mounting location, thereby eliminating the need for a separate mounting base.

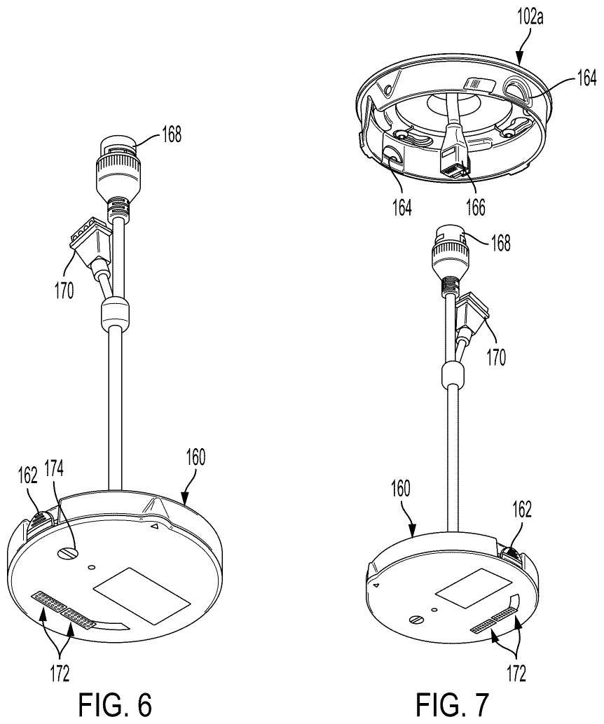

Modular sensor system may optionally include a network hub 160. With reference to FIGS. 2, 4, 6 and 7, network hub 160 is configured to be received within cavity 110 that is defined in mounting base 102a, and secured therein using a snap-lock connection, for example. Snap-lock feature may include, for example, one or more flexible arms 162 that are configured to snap into a corresponding aperture 164 to secure network hub 160 to mounting base 102a. Network hub 160 may further include a power interface and a network interface to transmit power and/or data to one or more sensor modules 180 that are connected to fixture 116a, as will be described in further detail below. In one exemplary embodiment, network hub 160 may be adapted to accept power over Ethernet (POE) to distribute both power and data from a power and/or network connector 166 to the one or more sensor modules 180 using a plug 168. In other embodiments, network hub 160 may distribute power and/or data from any suitable power source to the plurality of sensor modules 140 using an I/O plug 170. Plugs 168, 170 may in turn be connected to one or more network hub connection ports 172 for being directly or indirectly electrically connected to the one or more sensor modules 180. While one example has been provided above, it should be understood that network hub 160 may also, or alternatively, provide network connectivity through any suitable wired or wireless means. Network hub 160 may further include a reset button 174, and one or more sockets (not shown) for receiving a memory card (e.g., a secure digital (SD) memory card, a micro SD memory card, Compact Flash memory cards, CFexpress memory cards, or the like). In other embodiments, the one or more sockets may be disposed in the one or more sensor modules. Network hub 160 may be configured to store and maintain all configuration data for the plurality of sensor modules. Additionally, network hub 160 may include alarm input/output (I/O) contacts for integration to other devices.

As best seen in FIGS, 1, 2 and 4, sensor unit 100a may comprise a first sensor module 180a selected from one or more sensor modules 180 included in the modular sensor system. It should be understood that the one or more sensor modules may include a plurality of sensor modules. As discussed above, fixture 116a includes first and second ends, wherein the first end of fixture 116a is configured to be releasably coupled with mounting base 102a using the first universal connection mechanism. The second end of fixture 116a may include one or more mounting port 182, that is configured to be releasably coupled to sensor module 180a using a second universal connection mechanism to allow an installer of the modular sensor system to select the type(s) of sensor module(s) used in a particular installation context. For example, the second universal connection mechanism may comprise a first interlocking feature associated with a sidewall 184 of sensor module 180a, and a second interlocking feature associated with the second end of fixture 116a, wherein the first interlocking feature may be configured to releasably engage the second interlocking feature to allow sensor module 180a to be releasably and securably coupled to mounting port 182 of fixture 116a. It should be understood that the first and second interlocking features in the second universal connection mechanism may be either the same or different than those used the first universal connection mechanism used to releasably couple mounting base 102, 102a to the first end of fixture 116, 116a.

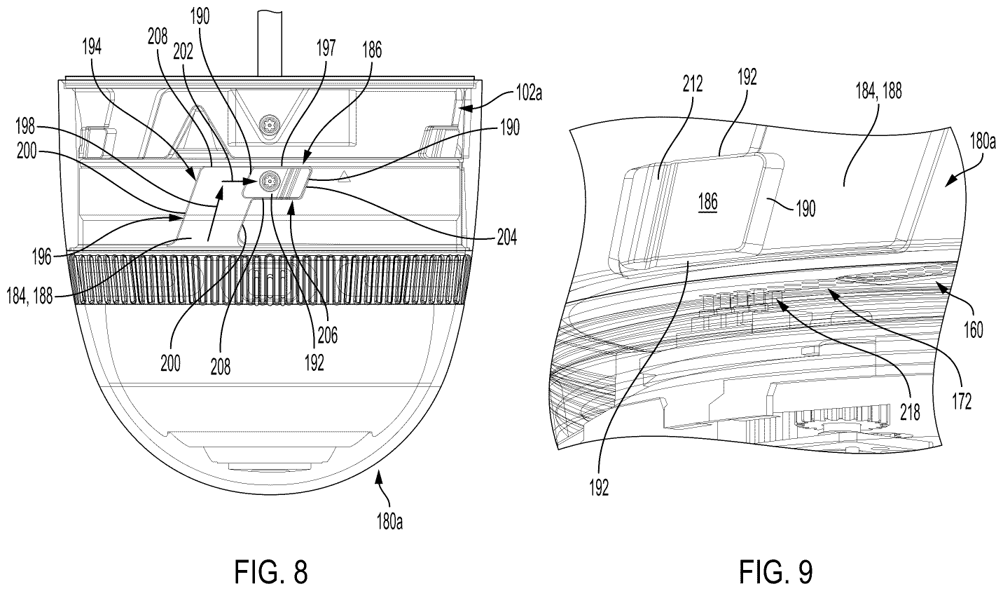

In a non-limiting example, with reference to FIGS. 4, 8 and 9, sidewall 184 of first sensor module 180a may include a plurality of protrusions 186 that are spaced around and extending from an outer surface 188 of sidewall 184. One or more of protrusions 186 may be, for example, shaped as quadrilateral, such as a parallelogram, that includes a first set of opposing sidewalls 190 and a second set of opposing sidewalls 192. It should be understood that protrusions 186 may be the same or a different shape as protrusions 122 discussed above with respect to the first universal connection mechanism. Protrusions 186 may be configured to be releasably positioned within with corresponding grooves 194 defined in the second end of fixture 116a to secure sensor module 180a to fixture 116a. In one exemplary embodiment, protrusions 186 spaced around the outer surface of sidewall 184 may be releasably positioned within corresponding grooves 194 defined in inner surface 134 of the second end of fixture 116a. To secureably connect sensor module 180a to fixture 116a, each protrusion 186 may be positioned within a first leg 196 of respective groove 194, and then sensor module 180a is moved in a direction 198. To guide movement of protrusion 186 in direction 198, first set of opposing sidewalls 190 may be disposed at an angle that matches opposing walls 200 of first leg 196 of groove 194. Further, each protrusion 186 may then be securely positioned within its respective groove 194 by twisting sensor module 180a in a direction 202 so that protrusion 186 moves to a distal end 204 of a second leg 206 of groove 194. To guide movement in direction 202, second set of opposing sidewalls 192 may be disposed at an angle that matches opposing walls 208 of second leg 206 of groove 194. Both protrusion 186 and an inner surface 210 of second leg 206 of groove 194 may optionally include respective ridges 212, 214 that interact with one another to generate a snap feel and/or sound to indicate to a user that protrusion 186 has reached a fully secure position at distal end 204 of second leg 206. In addition, or alternatively, fixture 116a may have a second aperture 216 defined therein that is positioned to line up with a receiving aperture 215 defined in one or more of protrusions 186 of sensor module 180a when sensor module 180a is securely connected to fixture 116a so that a captive lock screw 217 can be disposed therein to prevent authorized removal of sensor module 180 from fixture 116a.

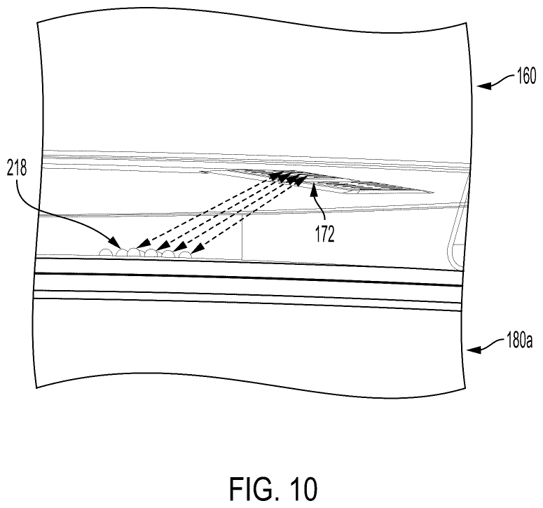

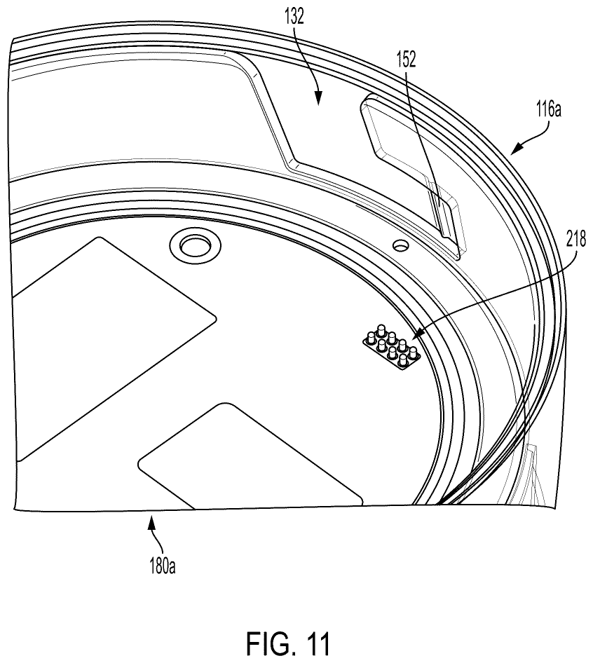

With reference to FIGS. 9-11, as sensor module 180a is being moved in direction 202 so that protrusion 186 is placed in a secure position within groove 194, power and data communication are also provided to sensor module 180a, such as through network hub 160. For example, sensor module 180a may include one or more connectors 218, such as spring-loaded pin connectors, that are configured for being placed in contact with connection ports 172 disposed on network hub 160 to provide for power and data communication between sensor module 180a and network hub 160.

The one or more sensor modules 180 included in the modular sensor system may be self-sealed network devices. Additionally, sensor modules 180 may include at least one sensor, a processor, and a memory. In certain embodiments, sensor modules 180 may be hermetically sealed. Any of the plurality of sensor modules 180 may be utilized in any of mounting ports 182 on any of the fixtures 116 as each mounting port 182 and each of the plurality of sensor modules 180 may be releasably coupled to one another in the same manner.

Sensor modules 180 may include a variety of different camera types, internet-of-things (IoT) devices, input/output (I/O) modules, thermal sensors, light detection and ranging (LiDAR) sensors, radio detection and ranging (RADAR) sensors, environmental sensors, and the like.

In some embodiments, sensor modules 140 may include a camera module powered by a system-on-chip (SoC) including neural network (NN) artificial intelligence (Al) processing. The camera module may be remotely positionable in providing pan, tilt, zoom, and rotate (PTZR) functionality. In some embodiments, the camera module may utilize a starlight sensor, varifocal motorized zoom and focus lens. The camera module may further include an inertial measurement unit (IMU) sensor that automatically rotates a captured image upon the roll of the IMU sensor. The camera module of the plurality of sensor modules 140 may further include integrated microphone with noise cancellation, integrated speakers, and light emitting diodes (LEDs).

In some embodiments, the camera module may include a Zigbee module to support Zigbee alarms, sensors, and other devices for IoT integration. In some embodiments, the NN Al may be utilized to provide extended zoom range and enhance low light color in high dynamic range (HDR) images captured by the camera module.

Referring to FIG. 1, sensor modules 180 may include a variety of different camera types, IoT devices, I/O modules, thermal sensors, LiDAR sensors, RADAR sensors, environmental sensors, and the like. A camera module 220 of sensor modules 180 may further include integrated microphone 222 with noise cancellation, integrated speakers 224, and light emitting diodes (LEDs) 226 providing bi-directional communication at locations where sensor unit 100a is installed. In some embodiments, camera module 220 may include a Zigbee module to support Zigbee alarms, sensors, and other devices for IoT integration. Also, in some embodiments, the NN Al may be utilized to provide extended zoom range and enhance low light color in images captured by the camera module.

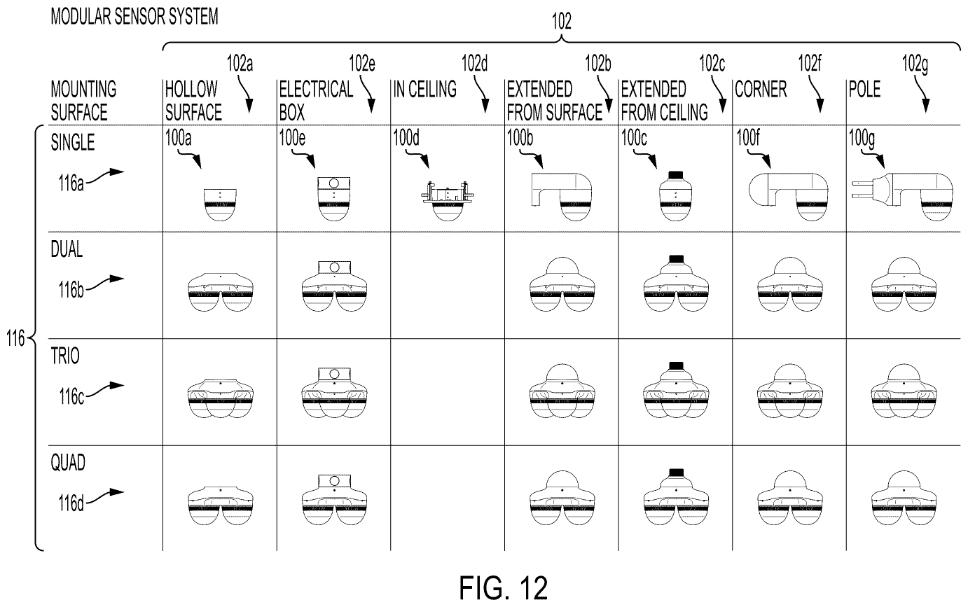

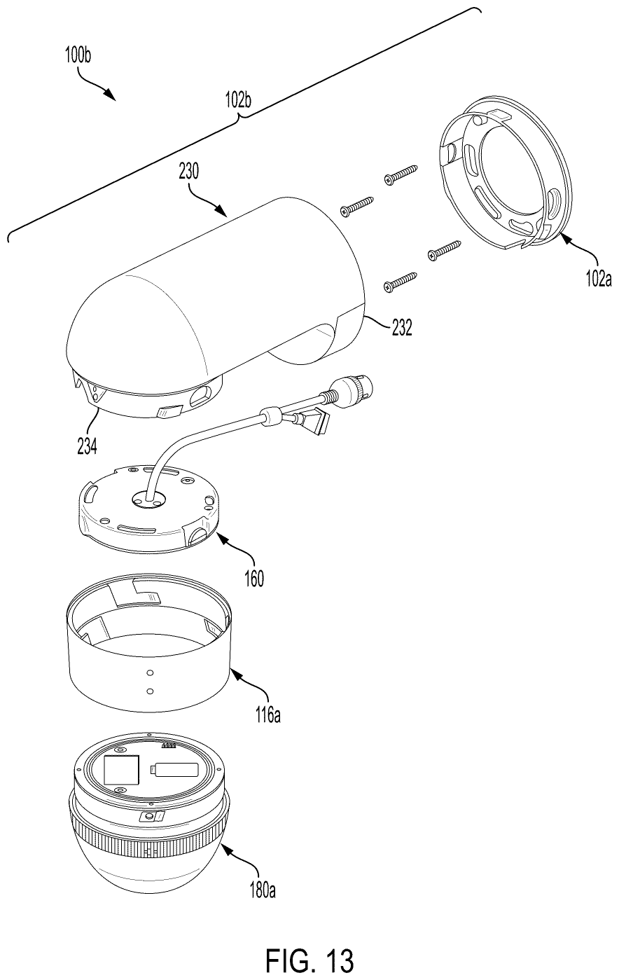

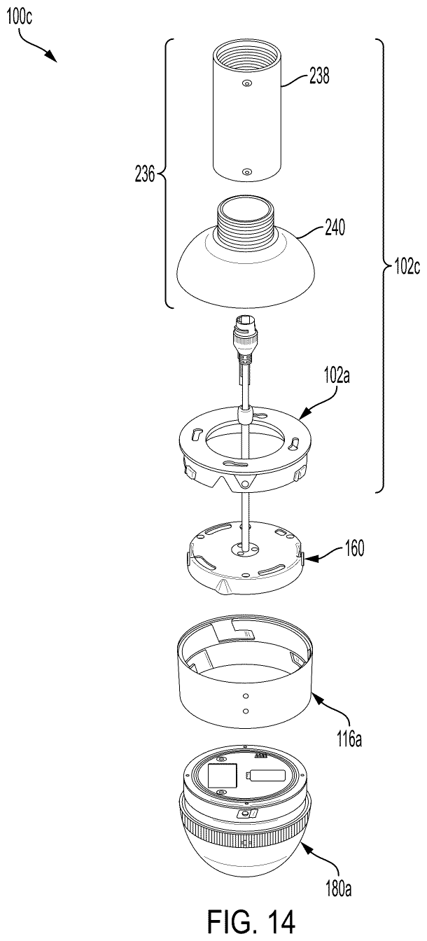

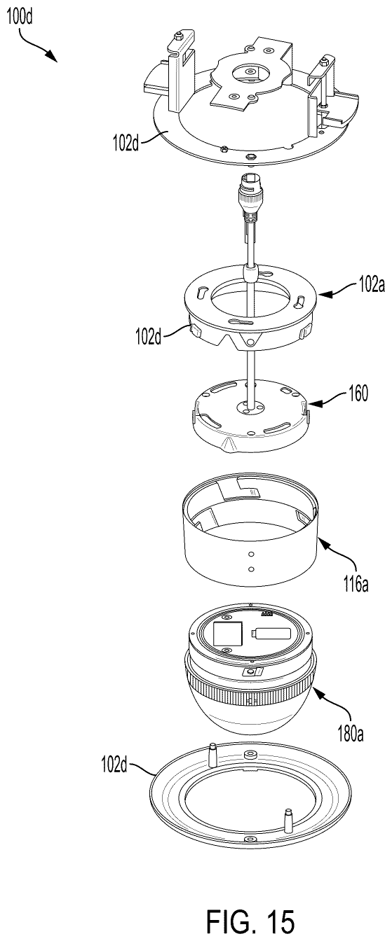

While the above-referenced description has illustrated one exemplary embodiment of sensor unit 100a that may be provided using modular sensor system, it is an aspect of the present invention to provide numerous other variations using the modular sensor system so that the resulting sensor unit can be contextualized for a particular location in which it is mounted and utilized. For example, as seen in FIG. 12, when sensor unit 100 is being configured an installer may select a mounting base from one or more different mounting bases 102. FIG. 13 illustrates another exemplary sensor unit 100b including a further exemplary mounting base 102b that may include hollow surface mount 102a (as described above) used in association with an extended mount 230 to provide for an extension from a mounting surface, such as a wall. Extended mount 230 may include the first universal connection mechanism at its first and second ends 232, 234 so that it can be connected to hollow surface mount 228 and the selected fixture 116 as previously described above. FIG. 14 illustrates another exemplary sensor unit 100c including a further exemplary mounting base 102c comprising hollow surface mount 102a used in association with a pole extender mount 236 to provide for an extension from a mounting surface, such as a ceiling. Pole extender mount 236 may include a pole member 238 that may be coupled at one end to a corresponding mount associated with the mounting location, and a dome 240 that is connected to the opposite end thereof. Hollow surface mount 102a may be connected to the dome 240 using one or more fasteners (not shown). FIG. 15 illustrates yet another exemplary sensor unit 100d including a further exemplary mounting base 102d comprising hollow surface mount 102a used in association with a ceiling mount assembly to accommodate a recessed mounting location. Ceiling mount assembly includes a ceiling bracket 242 that is fixedly mounted to a recessed mounting location, wherein hollow surface mount 102a may be fastened thereto using fasteners. Ceiling mount assembly may further include a cover plate 244 that is connected to ceiling bracket 242 to cover the rough opening in the ceiling.

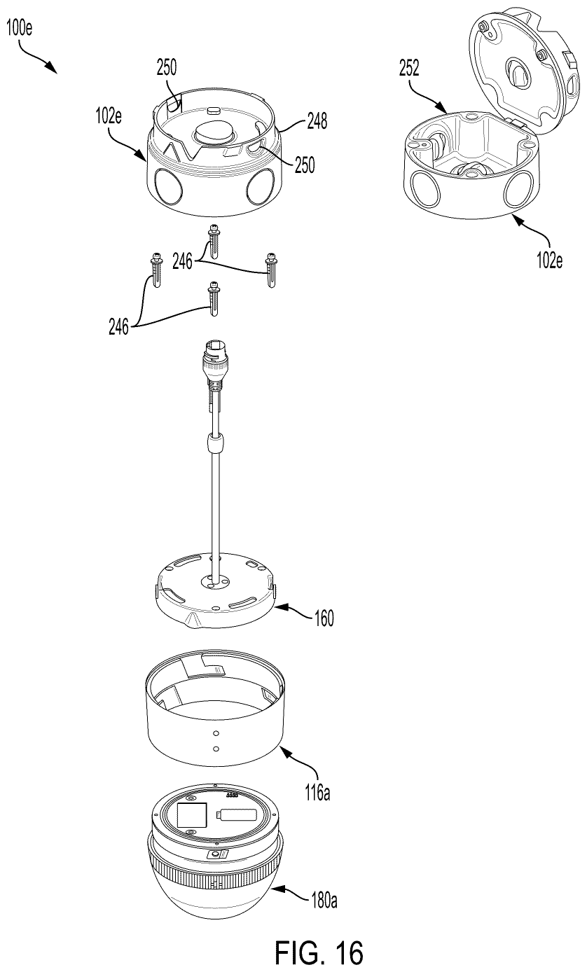

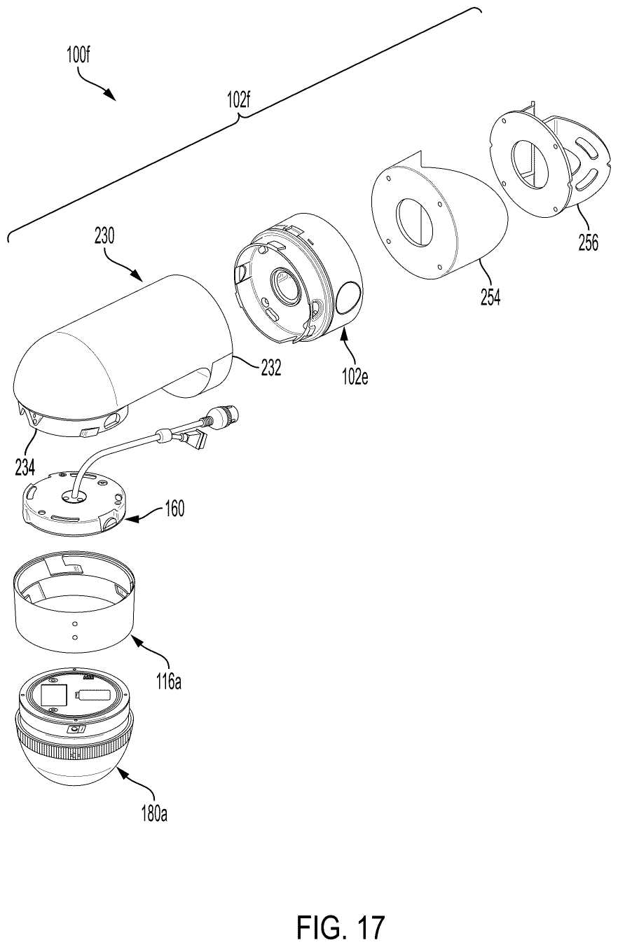

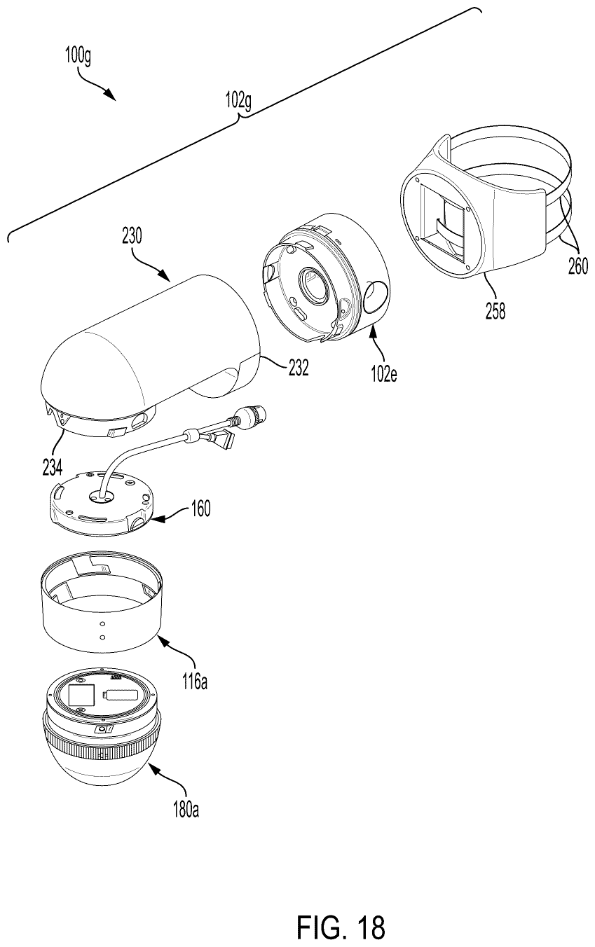

Other exemplary mounting bases 102 may also be provided in modular sensor system. As seen in FIG. 16, instead of using hollow surface mount 102a, another exemplary sensor unit 100e includes an electrical box 102e that may be used as the mounting base and configured for mounting to a mounting surface at a first end using fasteners 246. Electrical box may further include at a second end, for example, the first interlocking feature (e.g., protrusion) of the first universal connection mechanism in association with a sidewall 248 so that it can be secured to a selected fixture 116. Apertures 250 may be formed in sidewall 248 so that network hub 160 can be attached thereto. Electrical box 102e may further include an interior compartment 252 to allow power and/or network wires to be placed therein if necessary. FIG. 17 illustrates yet another exemplary sensor unit 100f that comprises another exemplary mounting base 102f comprising electrical box 102e (as described above) used in association with extended mount 230 to provide for an extension from a mounting surface, such as a wall. Extended mount 230 may include the first universal connection mechanism at its first and second ends 232, 234 so that it can be connected to electrical box 102e and the selected fixture 116 as previously described above. Mounting base 102f may further include alternative corner mounts, wherein corner mount 254 may be used for an outside corner mount scenario, and corner mount 256 may be used in an inside corner mount scenario. Each of these corner mounts 254, 256 may be coupled to the first end of electric box 102e and mounted to the respective mounting corner. FIG. 18 illustrates a further exemplary sensor unit 100g that includes another exemplary mounting base 102g comprising electrical box 102e (as described above) used in association with extended mount 230 to provide for an extension from an elongated member, such as a pole or beam, for example. Extended mount 230 may include the first universal connection mechanism at its first and second ends 232, 234 so that it can be connected to electrical box 102e and the selected fixture 116 as previously described above. Mounting base 102g may further include an adapter 258 that may be connected to electrical box 102e at one end, and one or more straps 260 that may be tightened and engaged with an elongated member to secure mounting base 102g thereto.

After a mounting base is selected from one or more different mounting bases 102, sensor unit 100 can be further contextualized by selecting a fixture from one or more different fixtures 116 to accommodate the number of sensor modules 180 that are desired for the installation. The use of the first universal connection mechanism allows any of the mounting bases 102 to be used with any selected fixture 116 to provide full adaptability to a given situation while at the same time reducing the complexity and time for the installation. Likewise, the use of second universal connection mechanism allows any of sensor modules 180 to be used with any selected fixture 116 to further reduce the complexity and time of the installation. FIG. 12 illustrates an exemplary array of sensor unit 100 combinations that may be provided using the different mounting bases 102 described above along with the exemplary fixtures 116 illustrated therein.

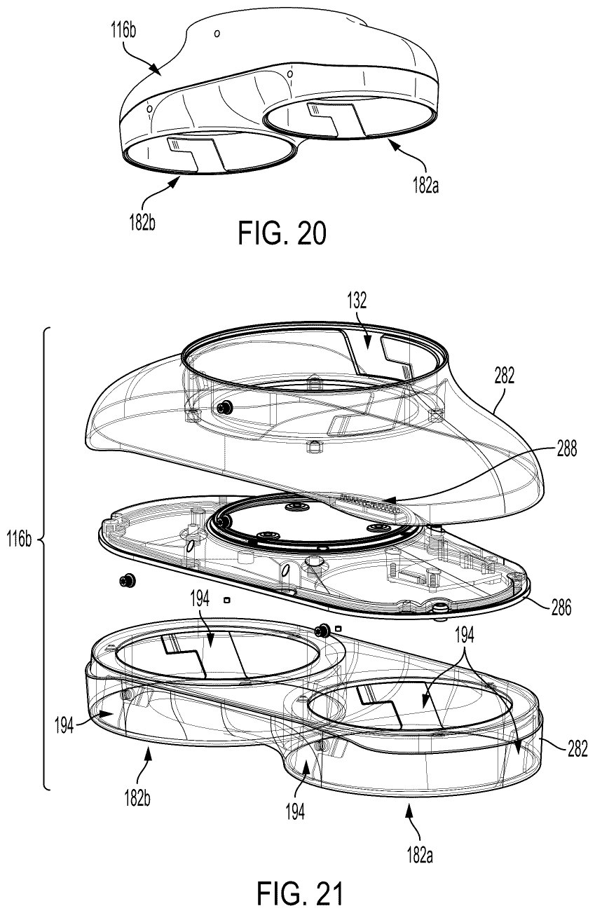

For example, as described above with reference to FIGS. 1-4 and 8, sensor unit 100a may include one mounting port 182 that may be associated with sensor module 180a. As an alternative to selecting fixture 116a, modular sensor system also may allow for the selection of one or more different fixtures 116. For example, FIGS. 12, 19 and 20 illustrate another exemplary fixture 116b that may be used to accommodate a different number of sensor modules 180a, 180b. With reference to FIG. 20, one end of fixture 116b includes two mounting ports 182a, 182b that, together with a respective sensor module 180a, 180b, each provide the second universal connection mechanism to allow for any sensor module 180 to be secured to mounting port thereby providing for complete interchangeability between sensor modules and fixture 116b. The other end of fixture 116b, provides an opening that, along with the selected mounting base 102, provides the first universal connection mechanism to allow fixture 116b to be secured to any of the mounting bases 102.

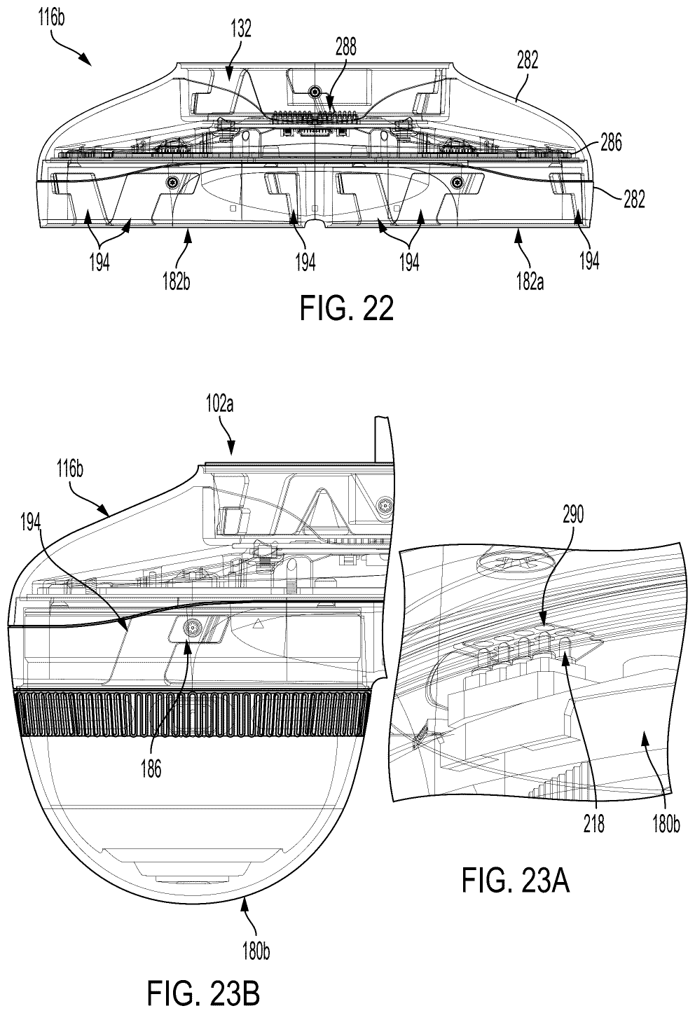

Fixture 116b may also allow sensor modules 180a, 180b to be connected to network hub connection port 172 of network hub 160 so that sensor modules 180a, 180b may be provided with power and/or data communication as described above. As seen in FIGS. 21, 22 and 23B, an exemplary, non-limiting fixture 116b may include a top shell 282 that includes the second interlocking feature of the first universal connection feature, a bottom shell 284 that defines mounting ports 182a, 182b and includes the second interlocking feature of the second universal connection feature, and a support frame 286 disposed therebetween. One or more network hub connectors 288, such as spring-loaded pin connectors, may be positioned on support frame 286 in a location so that they are placed in contact with connection ports 172 disposed on network hub 160 when network hub 160 is engaged with fixture 116b using the first universal connection mechanism. Further, with additional reference to FIG. 23A, one or more sensor module connection ports 290 may be positioned on support frame 286 in a location within each mounting port 182a, 182b so that they are placed in contact with connectors 218 disposed on respective sensor modules 180a, 180b when sensor modules 180a, 180b are engaged with fixture 116b using the second universal connection mechanism, as was described above. Sensor module connection ports 290 and network hub connectors 288 may be connected with one another using a cable, for example, that will allow for power and data communication between sensor module 180a and network hub 160.

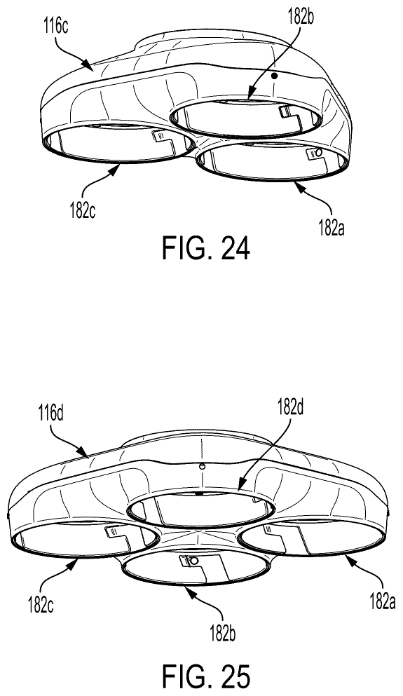

In yet another example, as seen in FIGS. 12, 19 and 24, modular sensor system further includes fixture 116c that includes a different number of mounting ports 182a, 182b, 182c compared to fixtures 116a, 116b. Thus, in this exemplary embodiment, fixture 116c may accommodate three sensor modules 180a, 180b, 180c. The manner of coupling fixture 116c to a selected mounting base 102 and a corresponding number of sensor modules 180 is similar to that which was described above with respect to fixture 116b.

In a further example, as seen in FIGS. 12, 19 and 25, modular sensor system further includes fixture 116d that includes a different number of mounting ports 182a, 182b, 182c, 182d compared to fixtures 116a, 116b, 116c. Thus, in this exemplary embodiment, fixture 116d may accommodate four sensor modules 180a, 180b, 180c, 180d. The manner of coupling fixture 116d to a selected mounting base 102 and a corresponding number of sensor modules 180 is similar to that which was described above with respect to fixture 116b.

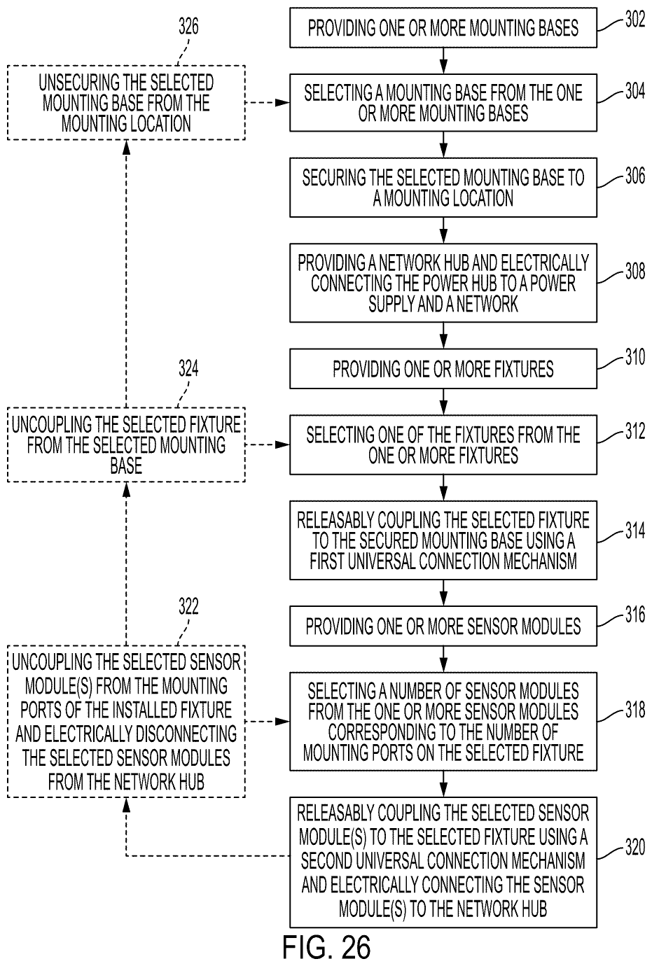

FIGS. 3, 4, 7, 12 and 26 illustrates an exemplary method 300 of using the modular sensor system to provide sensor unit and installing the same in accordance with aspects of the present invention. Method 300, at step 304, begins with providing one or more mounting bases (FIG. 12), and then proceeds with selecting a mounting base (e.g., 102a) from the one or more mounting bases 102 at step 304. Next, the selected mounting base is secured to a mounting location at step 306. The mounting location may be, for example, at least one of an interior surface 104 of a ceiling, an electrical box mounting in the ceiling, an exterior surface of the ceiling, a recess within the ceiling, an interior surface of a wall, an exterior surface of the wall, or a corner defined by two adjacent walls. The selected mounting base may be secured to the mounting location with fasteners (e.g., screws 107), by rotational coupling into a threaded receiver, with clips securing the mounting base to a surface, or by any other suitable fastener.

At step 308, method 300 may then proceed to provide a network hub 160 and electrically connect network hub 160 to a power supply and a network. For example, plug 168 extending from network hub 160 may be plugged into connector 166 to provide a connection to the power supply and network. In one embodiment, network hub 160 coupled to the selected mounting base with a snap-lock connection 162, 164 and accepts PoE and distributes both power and data to the sensor module(s) 180 that will be selected for use with the assembled sensor unit 100. In some embodiments network hub 160 may provide a status of network connections and PoE detection levels to a monitoring node on the network. Additionally, network hub 160 may be independently commissioned without the need for a sensor module to be installed. This may allow for separately commissioning the network prior to sensor installation/positioning and configuration. In some embodiments, network hub 160 may be battery powered, and in such case network hub 160 would not necessarily need to use plug 168 or connector 166 for the purpose of distributing power to the sensor module(s). Likewise, network hub 160 may wirelessly connect to a network, and in such case network hub 160 would not necessarily need to use plug 1689 and connector 166 for the purpose of communicating data between the network and the sensor module(s).

At step 310, one or more fixtures 116 (FIG. 12) are provided, wherein each fixture may be configured to be releasably coupled to the selected mounting base 102. Each fixture may have the same or different number of mounting ports 182 relative to the other fixtures of the plurality of shrouds 116. Each mounting port 182 included in each fixture may be configured to be releasably coupled to any of sensor modules 180.

At step 312, method 300 may then proceed to selecting a fixture (e.g., fixture 116a) from the one or more fixtures 116. At step 314, the selected fixture is releasably coupled to the selected mounting base using the first universal connection mechanism. For example, sidewall 108 of a second end of the selected mounting base may include a first interlocking feature 122, the first end of each of the fixtures 116 may include a second interlocking feature 132 (FIG. 2), and first interlocking feature 122 may be configured to releasably engage second interlocking feature 132. When the selected fixture is engaged with the selected mounting base, captive locking screw 158 (FIG. 4) may be used to prevent unauthorized removal of the selected fixture from the selected mounting base.

At step 316, method 300 may further include providing one or more sensor modules 180, and then proceed to select sensor module(s) (e.g., sensor module 180a) from one or more sensor modules 180 at step 318, wherein the selected number of sensor modules corresponds to the number of mounting ports 182 of the selected fixture.

At step 320, method 200 may then proceed to releasably coupling each of the selected sensor module(s) to respective mounting ports 182 on the selected fixture using the second universal connection mechanism. For example, each mounting port 182 in the first number of mounting ports 182 on the first fixture may include a first interlocking feature, each of the selected sensor modules may include a second interlocking feature, and the first interlocking feature may be configured to releasably engage the second interlocking feature. While the selected sensor module(s) are secured within the respective mounting ports 182 of the selected fixture, the selected sensor module(s) are also being electrically connected to network hub 160 using ports 172 and connectors 218, as described above. When the selected sensor module(s) are engaged with the selected fixture, a respective captive locking screw 217 (FIG. 4) may be used to prevent unauthorized removal of each of the selected sensor module(s) from the selected fixture. The assembly and installation of sensor unit 100a is then complete, contextualized to a particular operating environment, and may be operated to perform its intended function.

In some instances, a user's needs or resources may change after the initial installation of the sensor unit 100a. For example, a new area of a facility may need monitoring, it may be determined that a specific area of a facility does not require as many sensors or requires a different set of sensors to be utilized, or additional budgetary resources may become available. In such instances, a use may determine to alter the configuration of sensor unit 100a using the modular sensor system. In accordance with an aspect of the present invention, modular sensor system allows the selected mounting base to be interchanged with any of the mounting bases 102 in the modular sensor system; the selected fixture to be interchanged with any of the fixtures 116 in the modular sensor system; and/or the selected sensor module(s) to be interchanged with any of the sensor modules 180 available in the modular sensor system. Additional aspects for accomplishing the aforementioned functionality are described below.

In one exemplary embodiment, method 200 may further allow for the uncoupling one or more of the installed sensor module(s) from the respective mounting ports 182 of the installed fixture at step 322. This may be accomplished by disconnecting the second universal connection mechanism. While the installed sensor module(s) are being uncoupled with the respective mounting ports 182 of the selected fixture, the installed sensor module(s) are also being electrically disconnected to network hub 160 by separation of ports 172 and connectors 218. In certain embodiments, captive lock screw 217 may be present in each of the installed sensor module(s) to prevent unauthorized removal thereof. In such embodiments, captive lock screw 217 may need to be removed or loosened to facilitate uncoupling of each of the installed sensor modules from the respective mounting ports of the installed fixture. After step 322 is completed, method 300 may proceed back to step 318 as previously discussed to select replacement sensor module(s) for installation in mounting ports 182 of the selected fixture.

After one or more of the installed sensor module(s) have been uncoupled from the installed fixture at step 322, method 300 may further provide for uncoupling of the installed fixture from the installed mounting base at step 324. This may be accomplished by disconnecting the first universal connection mechanism. In certain embodiments, captive lock screw 158 may be present the installed fixture to prevent unauthorized removal of the installed fixture from the installed mounting base. In such embodiments, captive lock screw 158 may need to be removed or loosened to facilitate uncoupling of the installed fixture from the installed mounting base. After step 324 is completed, method 300 may proceed back to step 312 as previously discussed to select a replacement fixture from the one or more fixtures 116 for mounting to selected mounting base.

After the installed fixture has been uncoupled from the installed mounting base at step 324, method 300 may further provide for unmounting of the installed mounting base from the mounting location at step 326. In order to unmount the installed mounting base from the mounting location, it may be necessary to first disconnect network hub 160 from the installed mounting base. After step 326 is completed, method 300 may proceed back to step 304 as previously discussed to select a replacement mounting base from the one or more mounting bases 102 for mounting to the selected mounting location.

As illustrated from the above-referenced description, the modular sensor system of present invention provides for interchangeability of one or more mounting bases, one or more fixtures, and one or more sensor modules, which allows an installer to contextualize a sensor unit for a particular installation scenario.

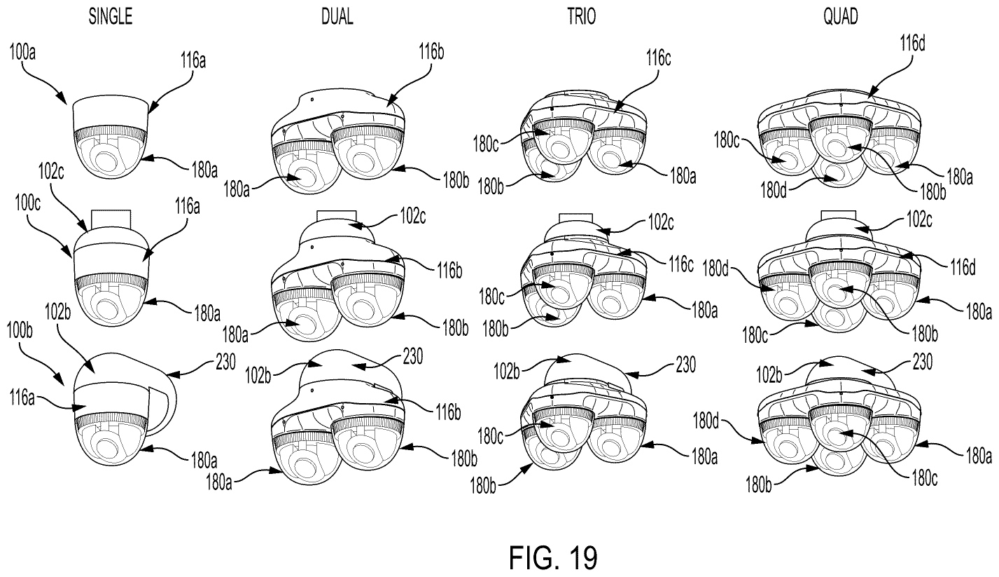

FIGS. 12 and 19 illustrate arrays of mounting base and fixture embodiments in accordance with exemplary aspects of the present invention. The universal nature of network hub 160 and the plurality of sensor modules 180 with uniform data I/O and power sockets and connectors extend the variably configured modular sensor array from a single sensor module to a plurality of sensor modules. The modular sensor system may include a plurality of mounting bases 102 mountable to a variety of mounting locations, each of mounting bases 102 including uniform configurations to releasably couple to each of the plurality of fixtures 116. As mentioned above, each of the plurality of fixtures 116 may include universal sensor sockets to releasably couple to any of sensor modules 180.

As illustrated in FIG. 12, the plurality of fixtures 116 can include fixture 116a with a single mounting port for a single sensor module, fixture 116b with dual-mounting ports 182 for two sensor modules 180a, 180b, fixture 116c with tri-mounting ports for three sensor modules 180a, 180b, 180c, and fixture 116d with quad-mounting ports for four sensor modules 180a, 180b, 180c, 180d. It is also contemplated that fixtures 116 in the present invention be configured with more than four mounting ports 182. Additionally, the first end of mounting base 102 may be configured to be disposed on an outer surface of a hollow mounting location, disposed on any common outdoor electrical box (e.g., 1-gang electrical boxes, 2-gang electrical boxes, 4 SQ electrical boxes, octagonal electrical boxes, etc.), disposed within a recess defined in the mounting location, configured to be an angled bracket, disposed on a threaded end of an elongated pole; or disposed in contact with the mounting location, wherein the mounting location may be a corner defined by two adjacent walls. While any of fixtures 116 may be mounted to any configuration of mounting base 102, the nature and geometry of the facility or installation surface may require that certain fixtures be utilized in certain scenarios.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A modular sensor system configured for providing a sensor unit that is contextualized for an installation scenario, the modular sensor system comprising:
one or more sensor modules;
one or more mounting bases, wherein each mounting base is configured for being mounted to a mounting location; and
one or more fixtures, wherein each of the one or more fixtures includes one or more mounting ports, wherein each of the one or more fixtures are configured for being releasably coupled to any of the one or more mounting bases using a first universal connection mechanism, and wherein each of the one or more mounting ports is configured for being releasably coupled with any of the sensor modules included in the one or more sensor modules using a second universal connection mechanism.

2. The modular sensor system in accordance with claim 1, further comprising a network hub including a power interface, wherein the power interface is configured to provide power from a power source to the one or more sensor modules when releasably coupled to any of the one or more fixtures.

3. The modular sensor system in accordance with claim 2, wherein the network hub includes a network interface, and wherein the network interface is configured to provide communication between the one or more sensor modules and a network when releasably coupled to any of the one or more fixtures.

4. The modular sensor system in accordance with claim 3, wherein the power interface and the network interface include uniform data I/O and power sockets and connectors.

5. The modular sensor system in accordance with claim 3, wherein the network hub is releasably coupled to any of the one or more mounting bases.

6. The modular sensor system in accordance with claim 1, wherein the first universal connection mechanism comprises a first interlocking feature associated with any of the one or more mounting bases, and a second interlocking feature associated with any of the one or more fixtures, wherein the first interlocking feature is configured to releasably engage the second interlocking feature.

7. The modular sensor system in accordance with claim 6, wherein one of the first interlocking feature or the second interlocking feature includes a protrusion, wherein the other of the first interlocking feature or the second interlocking feature includes a groove, and wherein the protrusion is configured for being twistably inserted into the groove to releasably couple any of the one or more fixtures to any of the one or more mounting bases.

8. The modular sensor system in accordance with claim 1, wherein the second universal connection mechanism comprises a first interlocking feature associated with each mounting port in any of the one or more fixtures, and a second interlocking feature associated with each of the one or more sensor modules, and the first interlocking feature is configured to releasably engage the second interlocking feature.

9. The modular sensor system in accordance with claim 8, wherein one of the first interlocking feature or the second interlocking feature includes a protrusion, wherein the other of the first interlocking feature or the second interlocking feature includes a groove, and wherein the protrusion is configured for being twistably inserted into the groove to releasably couple any of the one or more sensor modules to any of the mounting ports on the one or more fixtures.

10. The modular sensor system in accordance with claim 1, wherein the first universal connection mechanism and the second universal connection mechanism are the same.

11. The modular sensor system in accordance with claim 1, wherein each of the one or more sensor modules comprises a processor and a memory.

12. The modular sensor system in accordance with claim 1, wherein the one or more sensor modules comprises at least one of:
a camera;
a microphone;
a speaker;
an environmental sensor;
a thermal sensor;
a radar device;
a lidar device; or
an internet-of-things (IoT) device.

13. The modular sensor system in accordance with claim 1, wherein the mounting location is at least one of an interior surface of a ceiling, an electrical box mounting in the ceiling, an exterior surface of the ceiling, a recess within the ceiling, an interior surface of a wall, an exterior surface of the wall, or a corner defined by two adjacent walls.

14. The modular sensor system in accordance with claim 1, wherein the one or more mounting bases is a plurality of mounting bases, the one or more fixtures is a plurality of fixtures, and the one or more sensor modules is a plurality of sensor modules.

15. A method of installing a sensor unit using a modular sensor system, the modular sensor system providing one or more mounting bases, one or more fixtures, and one or more sensor modules, the method comprising:
a) selecting a mounting base from the one or more mounting bases;
b) securing the mounting base to a mounting location;
c) electrically connecting a network hub to a power supply and a network, and releasably coupling the network hub to the mounting base;
d) selecting a fixture from the one or more fixtures, wherein each of the one or more fixtures includes one or more mounting ports;
e) releasably coupling the selected fixture to the selected mounting base using a first universal connection mechanism;
f) selecting a number of sensor modules from the one or more sensor modules corresponding to the number of mounting ports on the selected fixture; and
g) releasably coupling the selected sensor modules to the selected fixture using a second universal connection mechanism and electrically connecting the sensor modules to the network hub.

16. The method in accordance with claim 15, wherein after step g) the method further comprises the steps of:
uncoupling the selected sensor modules from the one or more mounting ports of the selected fixture and electrically disconnecting the selected sensor modules from the network hub; and
returning to step f).

17. The method in accordance with claim 15, wherein after step g) the method further comprises the steps of:
uncoupling the selected sensor modules from the one or more mounting ports of the selected fixture and electrically disconnecting the selected sensor modules from the network hub;
uncoupling the selected fixture from the mounting base; and
returning to step d).

18. The method in accordance with claim 15, wherein after step g) the method further comprises the steps of:
uncoupling the selected sensor modules from the one or more mounting ports of the selected fixture and electrically disconnecting the selected sensor modules from the network hub;
uncoupling the selected fixture from the mounting base;
uncoupling the network hub form the mounting base;
unsecuring the mounting base from the mounting location; and
returning to step a).
